(19) United States
(12) Patent Application Publication
(10) Pub. No.: US 2015/0009316 A1
(43) Pub. Date: Jan. 8, 2015

(54) Live Camera Feed Welding Helmet

(71) Applicant: Aaron Baldwin, Eleebana (AU)

(72) Inventor: Aaron Baldwin, Eleebana (AU)

(21) Appl. No.: 13/965,138

(22) Filed: Aug. 12, 2013

Related U.S. Application Data
(60) Provisional application No. 61/841,943, filed on Jul. 2, 2013.

(51) Int. Cl. H04N 5/225

(52) U.S. Cl. CPC H04N 5/2257
USPC 348/90

(57) ABSTRACT

The present invention Live Camera Feed Welding Helmets purpose is to stop all UV radiation from entering the welding helmet and damaging the users eyes. The camera section contains a camera lens, relevant electronic components and lcd screen to view the welding work being done by the user. The opposite end of the camera section is fixed or hinged to the welding helmet.

### BACKGROUND

The present invention is in the technical field of welding.

More particularly, the present invention is in the technical field of welding helmets.

### BRIEF DESCRIPTION OF DRAWINGS

FIG. 1 is a perspective view of the hinged section containing camera of the present invention.

FIG. 2 is a perspective view of the inside of the viewing section containing the camera of the present invention.

FIG. 3 is a front view of the present invention

FIG. 4 is a perspective view of the camera section and helmet moulded as one of the present invention.

### SPECIFICATION

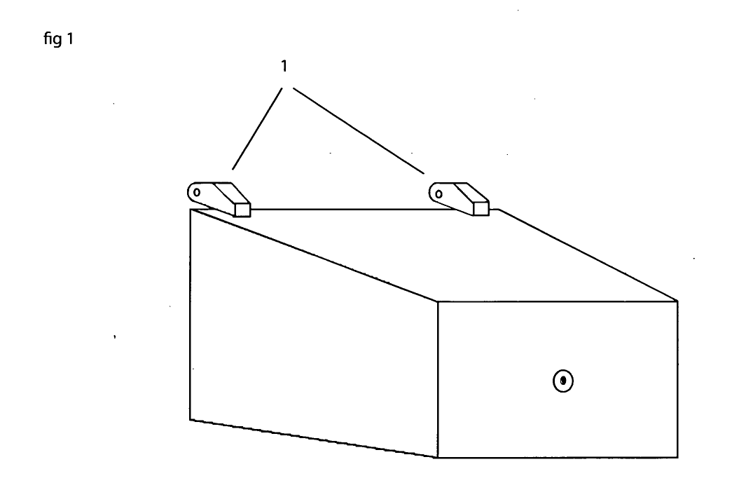

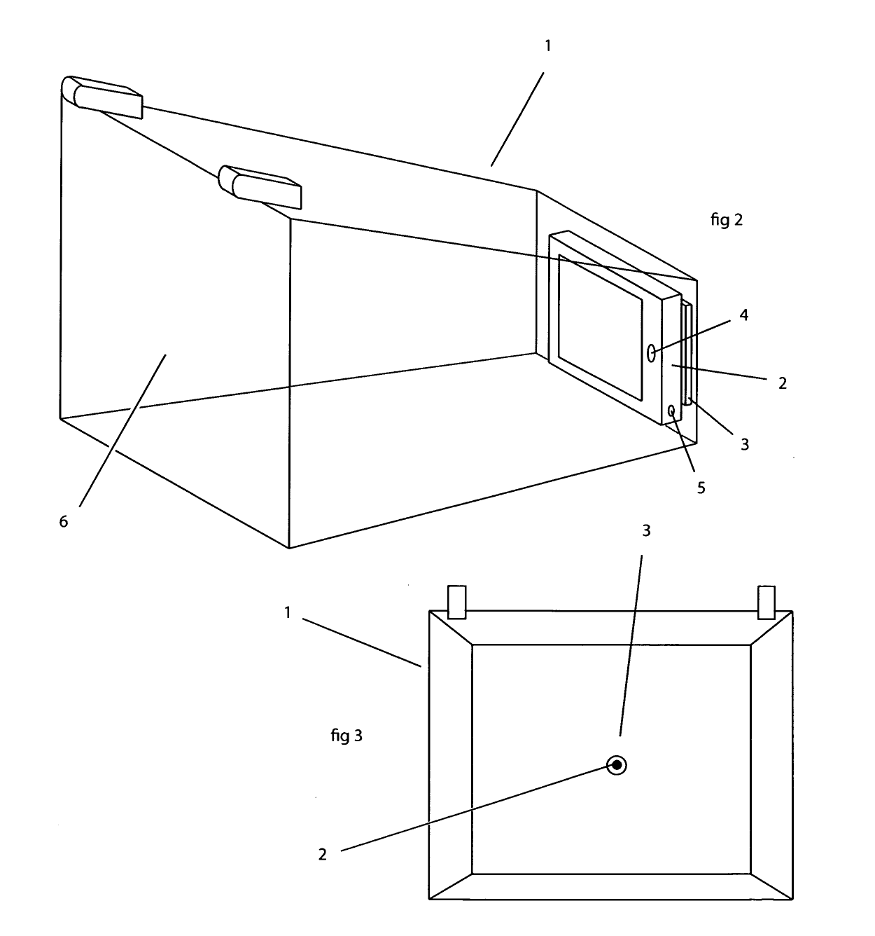

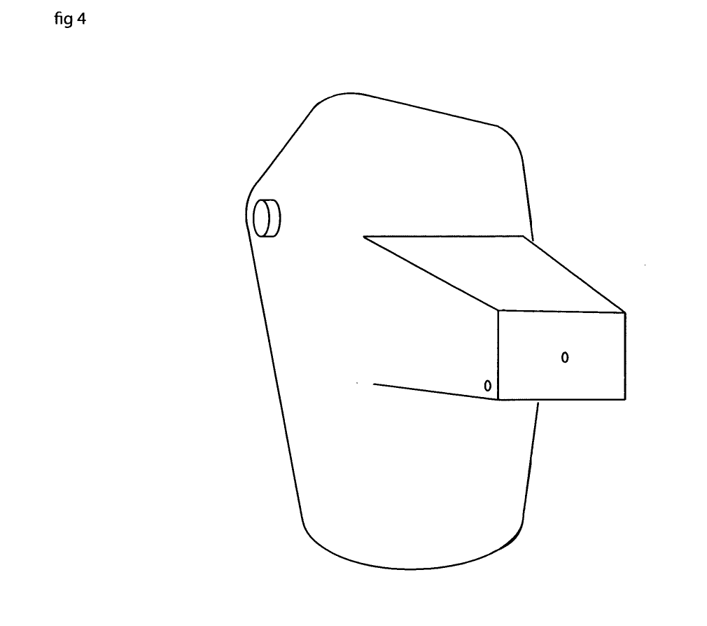

The present invention being the Live Camera Feed Welding Helmet has a section 1 (FIG. 2) containing a lens and video screen 2 (FIG. 2) to view the welding work being done by the user. The present invention can be made by plastic injection and plastic moulding and can be made of PP plastic for lightweight and durability. The welding helmet worn by the user and the invention is attached either by hinge 1 (FIG. 1) or moulded together as one (FIG. 4). The larger end of the section being open 6 (FIG. 2) to view down the compartment to the video screen.

The complete camera inside the viewing section is a live feed camera similar to a digital camera and contains the associated live video electronic components and necessary electronic or other filters to reduce the strong arc light. A camera lens 2 (FIG. 3) points out of an open hole 3 (FIG. 3) in the end of the compartment 1 (FIG. 3) to pick up the image of the work being done and sent via the camera realtime electronics components to the video screen. The camera lens is behind welding glass 3 (FIG. 2) to protect it.

The video screen can be a lcd screen or other type similar to a digital camera. The complete camera 2 (FIG. 2) is in plastic casing that can be clipped or fixed inside the viewing compartment 1 (FIG. 2). There is a on/off button 4 (FIG. 2) on the camera casing or outside of the viewing compartment to turn the camera on and off.

A battery inside the camera casing is also included to power the camera. The battery to power the camera is rechargeable and has an accessible point on the casing 5 (FIG. 2) for recharging.

1. (canceled)

2. (canceled)

3. (canceled)

4. (canceled)

5. (canceled)

6. (canceled)

7. (canceled)

8. (canceled)

9. The present invention is a welding helmet used for electric arc welding, the helmet for being mounted on the users head, said helmet having a front wall having upper and lower portions, a pair of laterally spaced side walls extending from said front wall defining an interior space to receive the users head therein, said front wall comprising an opening for the user to look through, attached to the centre of said front wall extending from the said opening is a hollow tapered box with top, bottom and lateral walls with the back open end connected to the front wall of said helmet, the front of said tapered box containing a camera comprising a camera lens, camera screen, associated electronics and non-rechargeable or rechargeable batteries Inside the front wall of tapered box, said front wall of tapered box having a hole In the centre of the wall for the said camera lens to receive the image of the electric arc welding work being done, said front of tapered box containing welding glass between said camera lens and inside front wall, said image of electric arc welding work being transferred through the said hole in tapered box front wall through said camera lens to said camera screen and along said tapered box to said hole in front wall of said welding helmet to users eye.

10. The present invention in claim 9, where said welding helmet extends a tapered box section which comprises a camera to view electric arc work being done and stop all UV A radiation from entering the users eyes.

11. The present invention in claim 9, where said camera comprises of a physical or electronic fitter to reduce the bright light of electric arc welding.

12. The present invention in claim 9, where said tapered box comprises of a physical filter to reduce the bright light of electric arc welding.

13. The present invention in claim 9, where said tapered box section is attached by hinge or moulded to front wall of said welding helmet.

14. The present invention in claim 9, where said tapered box section contains a complete camera comprising of said camera tens and associated electronic components which feeds a real-time Image of the electric arc welding work being done to a video screen.

15. The present invention in claim 9, where said camera inside front wall of said tapered box is used to block any UV radiation from entering the users eyes.

16. The present invention in claim 9, where said camera lens can be behind welding glass to protect it.

17. The present invention in claim 9, where said camera is removable from or fixed inside said tapered box.

18. The present invention in claim 9, where said camera screen can be set at a comfortable focal point for most users.

19. The present invention in claim 9, differs from all other welding helmets that only have transparent glass or auto darkening glass which allow UV A and other types of radiation to pass and damage the users eyes. I have seen from 15 years in the welding industry that many people have advanced cataracts in both eyes.

20. The present invention in claim 9, where said tapered box can be any shape or length.

21. The present invention in claim 9, the camera section being said tapered box contains said camera lens which feeds a real-time Image of the welding work being done to a video screen.

22. The present invention in claim 9, where said real-time feed camera located at the front of said tapered box section is used to block any UV radiation from entering the users eyes.

23. The present invention in claim 9, where said camera is set at a distance in said tapered box to suit the focal point of the welding helmet wearer.
